(19) United States
(12) Patent Application Publication
(10) Pub. No.: US 2002/0180663 A1
(43) Pub. Date: Dec. 5, 2002

(54) Method for manufacturing 3D image display body, and film for use in forming 3D image display body

(76) Inventors: Kazuo Maeda, Joetsu-City (JP); Yoshihiro Yoshirara, Nakakubiki-gun (JP)

Correspondence Address: Reveo, Inc., 85 Executive Blvd., Elmsford, NY, 10525, US

(21) Appl. No.: 09/873,690

(22) Filed: Jun. 4, 2001

(51) Int. Cl. G09G 5/00

(52) U.S. Cl. 345/9; 345/6; 348/54; 359/464

(57) ABSTRACT

The present invention provides a method for manufacturing a 3D image display body which is used to display 3D images in which right-eye image display parts a and left-eye image display parts b are mixed, this method including a phase-difference film that is disposed on a transparent support 1 with an adhesive agent 2 interposed. Resist members 4 are then disposed in specified positions on the aforementioned phase-difference film. The resulting assembly is then immersed in hot water and dried. A display member 5 is then superimposed or bonded on the side of the resist members 4.

### BACKGROUND OF THE INVENTION

The present invention relates to a method for manufacturing a 3D image display body that is used to display 3D images, and a film for use in forming such a 3D image display body.

3D image display devices such as that disclosed in (for example) U.S. Pat. No. 5,327,285 ('285) by Faris issued on Jul. 5, 1994 and hereby incorporated by reference. In this 3D image display device, as is shown in FIG. 1, a film 52 in which the right-eye image display parts a and the left-eye image display parts b are alternately disposed side by side is bonded to the surface of a liquid crystal member 14. When the light emitted by the liquid crystal member 14 is controlled so that a specified image is displayed, a right-eye image is displayed from the right-eye image display parts a, and a left-eye image is displayed from the left-eye image display parts b. Furthermore, since the device is constructed so that the direction of vibration of the polarized light constituting the right-eye image from the right-eye image display parts a has an angle of 90° relative to the direction of vibration of the polarized light constituting the left-eye image from the left-eye image display parts b (i.e., since the device is constructed so that, for example, the x component of the right-eye image consisting of two components x and y has a phase difference of 180° (π) with respect to the x component of the left-eye image which similarly consists of two components x and y), the observer can experience the sensation of observing a three-dimensional image when the aforementioned image is viewed using polarizing eyeglasses consisting of a polarizer-equipped right-eye lens that transmits only the right-eye image and a polarizer-equipped left-eye lens that transmits only the left-eye image.

With regard to the method used to manufacture the aforementioned film 12 in which right-eye image display parts a and left-eye image display parts b are alternately disposed side by side, such as film 12 has been manufactured in the past by a method in which a polarizing film formed by laminating a TAC film and an iodine-treated drawn PVA film is coated with a photoresist, specified portions of this coated film are exposed, and the film is then treated with a potassium hydroxide solution, so that the property that the drawn PVA film possesses of being able to rotate the direction of vibration of light in a specified wavelength region “as is” in a linearly polarized state (phase-difference function) is eliminated, as disclosed in FIG. 2 of the '285 patent. In this method, however, exposure and treatment with a potassium hydroxide solution must be performed following the application of the photoresist coating, so that this method is extremely troublesome. Several types of methods for manufacturing a film 12 by means of such a chemical treatment, and methods for manufacturing a film 12 by means of a physical treatment, etc., are disclosed in '285 patent. However, all of these manufacturing methods are similarly troublesome.

### SUMMARY OF THE INVENTION

The present invention provides a film in which right-eye image display parts a and lefteye image display parts b are mixed, and a method for manufacturing the same, which are greatly simplified and superior in terms of productivity. The object of the present invention is to allow the easy production of a film that has right-eye image display parts a and the left-eye image display parts b.

### BRIEF DESCRIPTION OF THE DRAWINGS

The present invention will be described with reference to the attached figures:

FIG. 1 is an explanatory diagram of a conventional 3D image display device; and.

FIG. 2 is an explanatory diagram of the construction of an embodiment of the present invention.

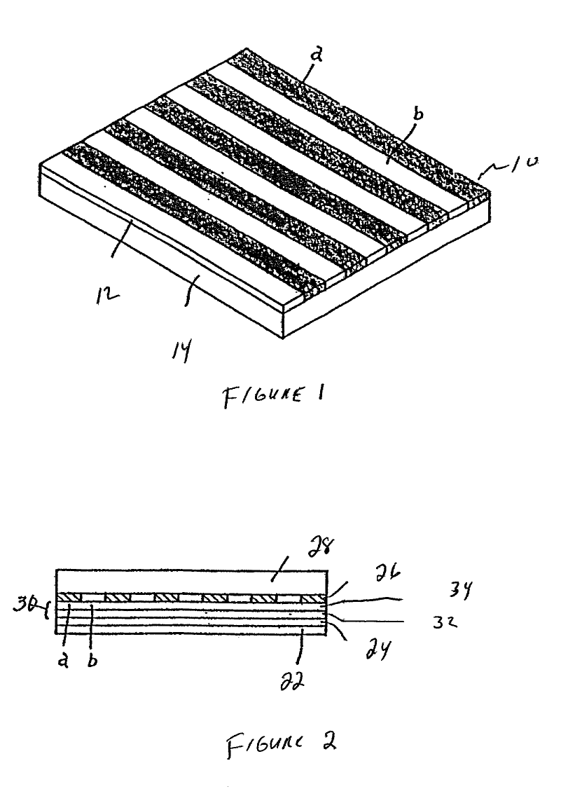

### DETAILED DESCRIPTION OF THE INVENTION

The present invention relates to a method for manufacturing a 3D image display body which is used to display 3D images in which right-eye image display parts a and left-eye image display parts b are mixed. This 3D image display body 20 is produced by a manufacturing method including a phase-difference film that is disposed on a transparent support 22 with an adhesive agent 24 interposed. Resist members 26 are then disposed in specified positions on the aforementioned phase-difference film. The resulting assembly is then immersed in hot water and dried. A display member 28 is then superimposed or bonded on the side of the resist members 26.

Furthermore, the present invention relates to a method for manufacturing a 3D image display body 20 which is used to display 3D images in which right-eye image display parts a and left-eye image display parts b are mixed, where the manufacturing method includes having a laminated phase-difference film 30 formed by laminating a TAC film 32 or CAB film, etc., and a drawn PVA film 34 that has a phase-difference function is disposed on a transparent support 22 with an adhesive agent 24 interposed so that the TAC film 32 is located on the side of the adhesive agent 24. Resist members 26 are then disposed in specified positions on the drawn PVA film 34. The resulting assembly is then immersed in hot water and dried. A display member 28 is then superimposed or bonded on the side of the resist members 26. The resist members 26 are linear bodies that are disposed at specified intervals from one side of the drawn PVA film 34 to the other side of said film 34.

Furthermore, the present invention relates to a 3D image display body 20 manufacturing method having the resist members 26 consist of a resist ink that is applied to the surface of the drawn PVA film 34 by screen printing.

Furthermore, the present invention relates to a 3D image display body 20 manufacturing method where the above-mentioned assembly is immersed for 5 seconds to 10 minutes in hot water at a temperature of 80 to 100° C.

Furthermore, the present invention relates to a film for use in forming a 3D image display body which is used to display a 3D image in which right-eye image display parts a and left-eye image display parts b are mixed, where the film for use in forming a 3D image display body has a laminated phase-difference film 30 formed by laminating a film that does not possess birefringence, such as a TAC film 32, etc., and a drawn PVA film 34 that has a phase-difference function is disposed on a transparent support 22 with an adhesive agent 24 interposed so that the film that does not possess birefringence is located on the side of the adhesive agent 24, and right-eye image display parts a and left-eye image display parts b are disposed in specified positions on the drawn PVA film 34.

When the above-mentioned assembly is immersed in hot water after the resist members 24 have been disposed in specified positions on the phase-difference film, water permeates the portions of the phase-difference film where no resist members 24 are present, so that these portions show a change in properties. As a result, the property of being able to rotate the direction of vibration of light in a specified wavelength region “as is” in a linearly polarized state (phase-difference function) is lost only in the above-mentioned portions of the film, thus producing a film in which the phase of the transmitted light is shifted 180° between portions where resist members 26 are present and portions where no resist members 26 are present.

Accordingly, a film in which the right-eye image display parts a and the left-eye image display parts b are mixed can be mass-produced by the simple operation of immersion in hot water.

FIG. 2 illustrates an embodiment of the present invention, which will be described in detail below. A laminated phase-difference film 3 formed by laminating a TAC film 6 (thickness: 126 μm) and a uniaxially drawn PVA film 7 (thickness: 38 μm) as a phase-difference film (½-wave plate) which has a phase-difference function is disposed on the surface of a transparent support 1 (e.g., a glass plate or cellulose acetate butyrate (CAB) plate, etc., with a thickness of about 2 mm) with an adhesive agent 2 (e.g., an ultraviolet-curable resin) interposed, and the ultraviolet-curable resin is cured by means of ultraviolet light. Furthermore, a glass plate that does not possess birefringence is most desirable as the support 1. Moreover, besides a film formed by laminating a TAC film 6 with a drawn PVA film 7, the laminated phase-difference film 3 may also be a film formed by laminating a CAB film with a drawn PVA film 7; in short, any film formed by laminating a film that does not possess birefringence with a drawn PVA film 7 may be used as the laminated phase-difference film 3.

Next, a resist ink with a high water resistance is applied to the uniaxially drawn PVA film 7 in specified positions as resist members 4 by means of screen printing. The resist ink in this case is applied in the form of linear bodies with a width of 160 μm, which are disposed on the surface of the drawn PVA film 7 from one side of the PVA film 7 to the other. These linear bodies are disposed side by side at a pitch of 160 μm.

Furthermore, it is not necessary that the resist ink have a uniform width and uniform pitch as described above. Moreover, the ink need not be applied in the form of linear bodies; it would also be possible, for example, to dispose square bodies (as seen in a plan view) in a staggered arrangement.

Next, this assembly is immersed for approximately 30 seconds in hot water at a temperature of 80° C. (of course, the peripheral surfaces are subjected to an appropriate waterproofing treatment), so that the orientation of the molecules in the drawn PVA film 7 is destroyed by allowing water to permeate into the portions where no resist ink is present, thus eliminating the aforementioned phase-difference function that was present in the state prior to drawing, i.e., the phase-difference function that is intrinsically possessed by the drawn PVA film 7. In this way, the portions where the resist ink is present are converted into (for example) right-eye image display parts a, and the portions where no resist ink is present are converted into left-eye image display parts b. As a result of various experiments, it has been confirmed that the properties of the above-mentioned drawn PVA film 7 are similarly lost if the film is immersed for 5 seconds to 10 minutes in hot water at a temperature of 80° C. to 100° C.

Next, with the above-mentioned assembly left “as is” in cases where the resist ink is transparent, or following the removal of the resist ink in cases where the resist ink is not transparent, a display member 5 which has a liquid crystal disposed inside is superimposed by means of a magnet, etc., or bonded by means of an appropriate adhesive agent, thus forming a 3D image display body.

The positions where the resist ink is applied, i.e., the positions of the right-eye image display parts a and left-eye image display parts b, are set so that they coincide with the pitch of the liquid crystal cells of the display member 28 that is bonded.

A film in which right-eye image display parts a and left-eye image display parts b are disposed side by side can easily be obtained by means of the above manufacturing method; accordingly, a 3D image display body can also easily be obtained.

Furthermore, if the respective members are provided in the form of rolls in the above-mentioned manufacturing process, continuous manufacture is possible, so that the productivity of the 3D image display body is improved even further.

When the image from the 3D image display body manufactured as described above is viewed through polarizing eyeglasses consisting of a polarizer-equipped right-eye lens that transmits only the right-eye image from the right-eye image display parts a and a polarizer-equipped left-eye lens that transmits only the left-eye image from the left-eye image display parts b (i.e., an image that is composed of light that vibrates in a direction that is 90° perpendicular to the direction of vibration of the light composing the right-eye image), the observer can experience the sensation of viewing the above-mentioned image as a three-dimensional image.

Furthermore, the present embodiment differs from the technique disclosed in '285 patent (in which right-eye image display parts and left-eye image display parts are formed in a polarizing plate) in that the right-eye image display parts a and the left-eye image display parts b are formed in a phase-difference film. Therefore, it is necessary to combine this phase-difference film with a display member 28 that emits polarized light.

It is understood that method of manufacturing a 3D image display body may be modified in a variety of ways which will become readily apparent to those skilled in the art of having the benefit of the teachings disclosed herein. All such modifications and variations of the illustrative embodiments thereof shall be deemed to be within the scope and spirit of the present invention as defined by the Claims to the invention appended hereto.

What is claimed is

1. A method for manufacturing a 3D image display body which is used to display 3D images in which right-eye image display parts and left-eye image display parts are mixed, said 3D image display body manufacturing method comprising:
disposing a phase-difference film on a transparent support with an adhesive agent interposed,
disposing a plurality of resist members in specified positions on said phase-difference film,
immersing a resulting assembly in hot water and drying said assembly; and
superimposing or bonding a display member onto said resist members.

2. A method for manufacturing a 3D image display body which is used to display 3D images in which right-eye image display parts and left-eye image display parts are mixed, said 3D image display body manufacturing method comprising:
forming a laminated phase-difference film by laminating a TAC film or CAB film, and a drawn PVA film that has a phase-difference function disposed on a transparent support with an adhesive agent interposed so that the TAC film is located on the side of the adhesive agent;
disposing said resist members in specified positions on saod drawn PVA film;
immersing said resulting assembly in hot water and dried; and
superimposing or bonding a display member on a side of said resist members.

3. The method of claim 2 wherein said resist members are linear bodies that are disposed at specified intervals from one side of the drawn PVA film to the other side of said film.

4. The method of either claim 2, wherein the resist members comprise a resist ink that is applied to the surface of the drawn PVA film by screen-printing.

5. The method of either claim 3, wherein the resist members comprise a resist ink that is applied to the surface of the drawn PVA film by screen-printing.

6. The method of claim 2, wherein the assembly is immersed for 5 seconds to 10 minutes in hot water at a temperature of 80 to 100° C.

7. The method of claim 3, wherein the assembly is immersed for 5 seconds to 10 minutes in hot water at a temperature of 80 to 100° C.

8. The method of claim 4, wherein the assembly is immersed for 5 seconds to 10 minutes in hot water at a temperature of 80 to 100° C.

9. A film for use in forming a 3D image display body that is used to display a 3D image in which right-eye image display parts and left-eye image display parts are mixed, said film for use in forming a 3D image display body comprising:
a laminated phase-difference film formed by laminating a film that does not possess birefringence; and
a drawn PVA film that has a phase-difference function disposed on a transparent support with an adhesive agent interposed so that the film that does not possess birefringence is located on the side of the adhesive agent, and right-eye image display parts and left-eye image display parts are disposed in specified positions on the drawn PVA film.
